(19) United States
(12) Patent Application Publication
(10) Pub. No.: US 2026/0074469 A1
(43) Pub. Date: Mar. 12, 2026

(54) FIRST TERMINAL MODULE WITH IMPROVED SHIELDING EFFECT AND ELECTRICAL CONNECTOR HAVING THE SAME

(71) Applicant: DONGGUAN LUXSHARE TECHNOLOGIES CO., LTD, Dongguan City (CN)

(72) Inventors: Kunlin YAO, Dongguan City (CN); Huanhuan SHEN, Dongguan City (CN)

(73) Assignee: DONGGUAN LUXSHARE TECHNOLOGIES CO., LTD, Dongguan City (CN)

(21) Appl. No.: 18/924,095

(22) Filed: Oct. 23, 2024

(30) Foreign Application Priority Data
Sep. 12, 2024 (CN) 202411281188.1

(51) Int. Cl. H01R 13/6585; H01R 12/72

(52) U.S. Cl. CPC H01R 13/6585; H01R 12/722

(57) ABSTRACT

A first terminal module includes a first conductive housing, a first conductive cover plate and a first terminal assembly. The first conductive cover plate is located on an inner side of the first conductive housing. The first terminal assembly includes a first signal terminal. The first signal terminal includes a first middle portion, a first signal elastic arm portion and a first tail portion. The first conductive housing covers the first signal elastic arm portion, the first middle portion and the first tail portion of the first signal terminal along a length direction of the first signal terminal, thereby improving the shielding effect on the first signal terminal. An electrical connector having the first terminal module is also disclosed.

### CROSS-REFERENCE TO RELATED APPLICATION

This patent application claims priority of a Chinese Patent Application No. 202411281188.1, filed on Sep. 12, 2024 and titled “FIRST TERMINAL MODULE AND ELECTRICAL CONNECTOR”, the entire content of which is incorporated herein by reference.

### TECHNICAL FIELD

The present disclosure relates to a first terminal module and an electrical connector, which belongs to the technical field of connectors.

### BACKGROUND

Electrical connectors in the related art generally include an insulating body and a plurality of terminal modules mounted to the insulating body. The terminal module includes a plurality of conductive terminals. As the signal transmission requirements of the electrical connectors continue to increase, the shielding effect of these types of electrical connectors is poor and it is increasingly unable to meet the needs.

For this reason, a technical solution in which a conductive housing is used to replace the insulating body is proposed in the related art. In a length direction of the conductive terminal, the conductive housing only covers part of the conductive terminal. Some part of the conductive terminal is fixed by a mounting block. However, the mounting block has a limited shielding effect on the conductive terminal. Besides, since the mounting block and the conductive housing are two parts, these two parts provide the poor shielding effect of the conductive terminals at a junction of the two parts.

Therefore, it is desirable to improve the electrical connector in the related art.

### SUMMARY

An object of the present disclosure is to provide a first terminal module with better shielding effect and an electrical connector having the first terminal module.

In order to achieve the above object, the present disclosure adopts the following technical solution: a first terminal module, including: a first conductive housing, the first conductive housing including a first main body portion, a first mating portion extending from one end of the first main body portion, and a first extension portion extending from another end of the first main body portion; a first conductive cover plate, the first conductive cover plate being located on an inner side of the first conductive housing; and a first terminal assembly, the first terminal assembly including a first insulating fixing block and a plurality of first signal terminals fixed to the first insulating fixing block; the first terminal assembly being at least partially located between the first conductive housing and the first conductive cover plate; each first signal terminal including a first middle portion, a first signal elastic arm portion extending from one end of the first middle portion, and a first tail portion extending from another end of the first middle portion; the first signal elastic arm portion including a first signal contact portion configured to be in contact with a mating module; the first signal terminals being not in contact with the first conductive housing; wherein the first conductive housing covers the first signal elastic arm, the first middle portion and the first tail portion of the first signal terminal along a length direction of the first signal terminal.

In order to achieve the above object, the present disclosure adopts the following technical solution: an electrical connector, including: a first terminal module, the first terminal module, including: a first conductive housing, the first conductive housing including a first main body portion, a first mating portion extending from one end of the first main body portion, and a first extension portion extending from another end of the first main body portion; a first conductive cover plate, the first conductive cover plate being located on an inner side of the first conductive housing; and a first terminal assembly, the first terminal assembly including a first insulating fixing block and a plurality of first signal terminals fixed to the first insulating fixing block; the first terminal assembly being at least partially located between the first conductive housing and the first conductive cover plate; each first signal terminal including a first middle portion, a first signal elastic arm portion extending from one end of the first middle portion, and a first tail portion extending from another end of the first middle portion; the first signal elastic arm portion including a first signal contact portion configured to be in contact with a mating module; the first signal terminals being not in contact with the first conductive housing; wherein the first conductive housing covers the first signal elastic arm, the first middle portion and the first tail portion of the first signal terminal along a length direction of the first signal terminal; and a second terminal module, the second terminal module including: a second conductive housing, the second conductive housing including a second main body portion, a second mating portion extending from one end of the second main body portion, and a second extension portion extending from another end of the second main body portion; a second conductive cover plate, the second conductive cover plate being located on an inner side of the second conductive housing; and a second terminal assembly, the second terminal assembly including a second insulating fixing block and a plurality of second signal terminals fixed to the second insulating fixing block; the second terminal assembly being at least partially located between the second conductive housing and the second conductive cover plate; each second signal terminal including a second middle portion, a second signal elastic arm portion extending from one end of the second middle portion, and a second tail portion extending from another end of the second middle portion; the second signal elastic arm portion including a second signal contact portion configured to contact the mating module; the second signal terminals being not in contact with the second conductive housing; wherein the second conductive housing covers the second signal elastic arm portion, the second middle portion and the second tail portion of the second signal terminal along a length direction of the second signal terminal; and wherein the first conductive housing of the first terminal module is in contact with the second conductive housing of the second terminal module to form a mating slot between the first conductive housing and the second conductive housing; the first signal contact portion of the first terminal module protrudes into the mating slot from one side, and the second signal contact portion of the second terminal module protrudes into the mating slot from an opposite side; the mating slot is configured to receive the mating module; the mating module is in contact with the first signal contact portion and the second signal contact portion.

Compared with the prior art, the first terminal module and the electrical connector of the present disclosure include the first conductive housing and the first conductive cover plate. The first terminal assembly is at least partially located between the first conductive housing and the first conductive cover plate to improve the shielding effect on the first signal terminal. Besides, the first conductive housing covers the first signal elastic arm portion, the first middle portion and the first tail portion of the first signal terminal along the length direction of the first signal terminal, thereby covering most of the first signal terminal in the length direction thereof, and improving the shielding effect on the first signal terminal.

### BRIEF DESCRIPTION OF DRAWINGS

FIG. 1 is a schematic perspective view of a connector assembly in accordance with an embodiment of the present disclosure, in which an electrical connector is mounted on a circuit board, and a mating module is inserted into a mating slot of the electrical connector;

FIG. 2 is a perspective view of FIG. 1 from another angle;

FIG. 3 is a partially exploded perspective view of FIG. 1, in which the electrical connector and the circuit board are separated from each other, and the mating module is separated from the electrical connector;

FIG. 4 is a partial enlarged view of a circled part B in FIG. 3;

FIG. 5 is a partially exploded perspective view of FIG. 3 from another angle;

FIG. 6 is a partially exploded perspective view of the electrical connector shown in FIG. 3;

FIG. 7 is a partially exploded perspective view of FIG. 6 from another angle;

FIG. 8 is a further partially exploded perspective view of FIG. 6;

FIG. 9 is a partially exploded perspective view of FIG. 8 from another angle;

FIG. 10 is an exploded perspective view of a first terminal module in FIG. 8;

FIG. 11 is an exploded perspective view of FIG. 10 from another angle;

FIG. 12 is an exploded perspective view of a second terminal module in FIG. 8;

FIG. 13 is an exploded perspective view of FIG. 12 from another angle;

FIG. 14 is an exploded perspective view of a third terminal module in FIG. 8;

FIG. 15 is an exploded perspective view of FIG. 14 from another angle;

FIG. 16 is an exploded perspective view of a fourth terminal module in FIG. 8;

FIG. 17 is an exploded perspective view of FIG. 16 from another angle; and

FIG. 18 is a schematic cross-sectional view taken along line C-C in FIG. 3.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

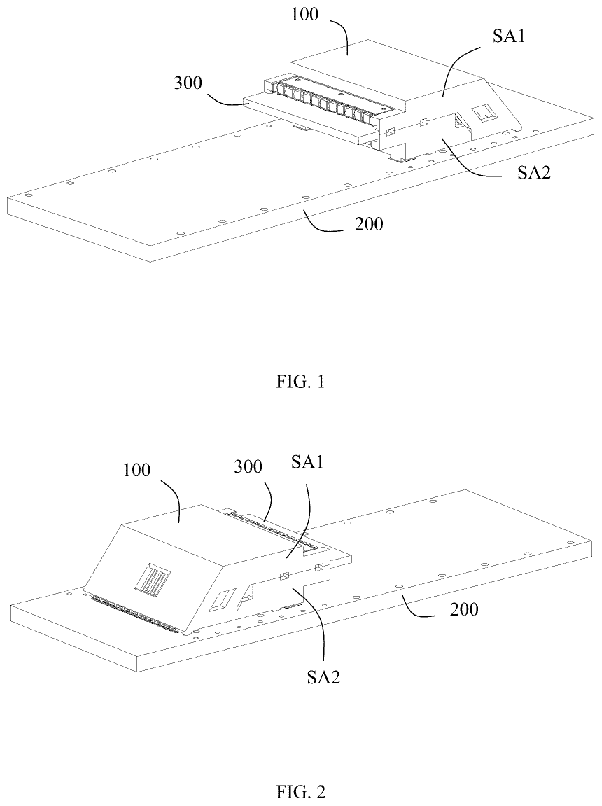

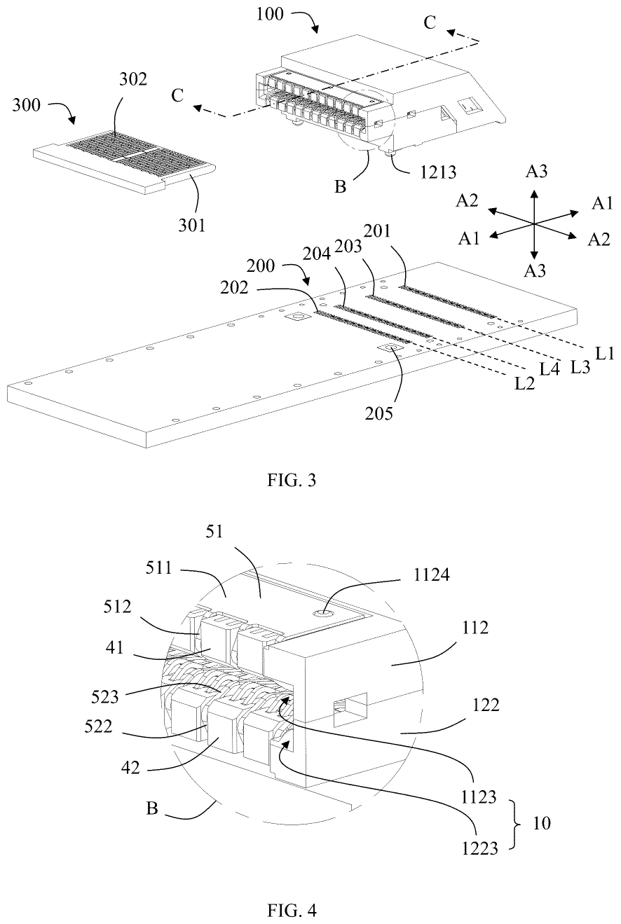

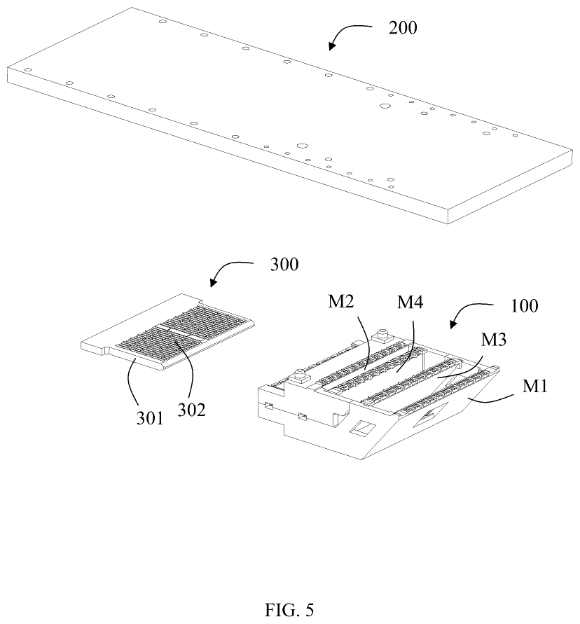

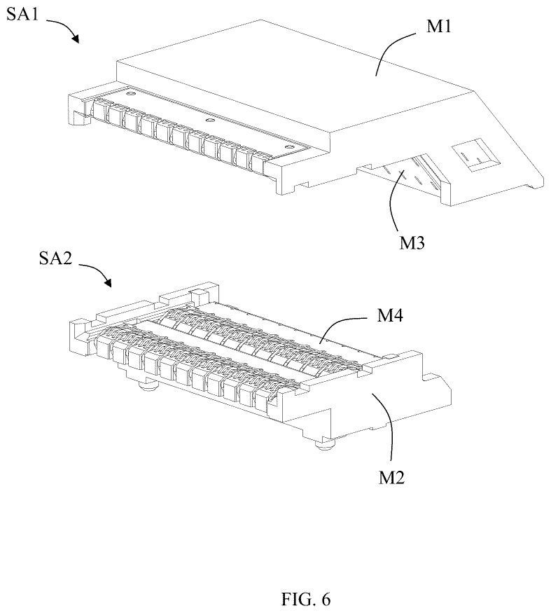

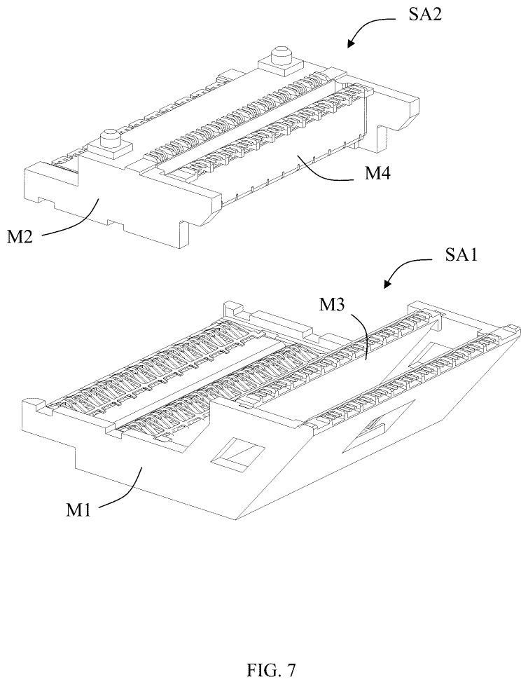

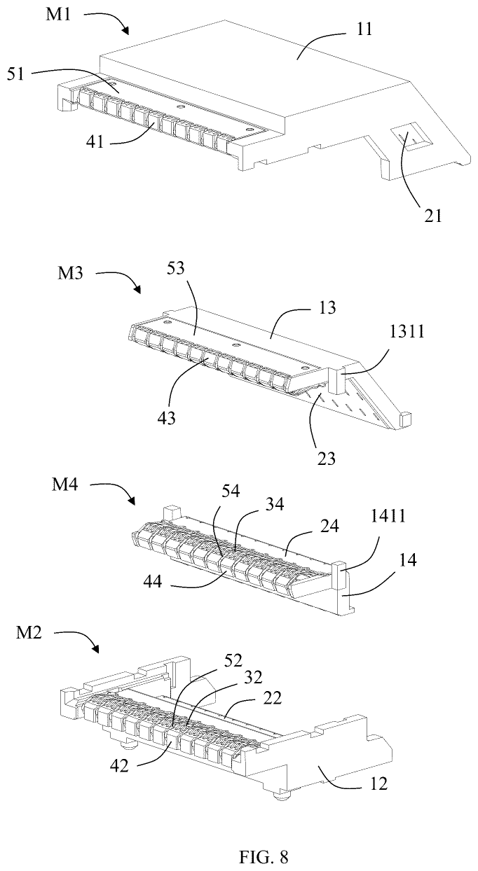

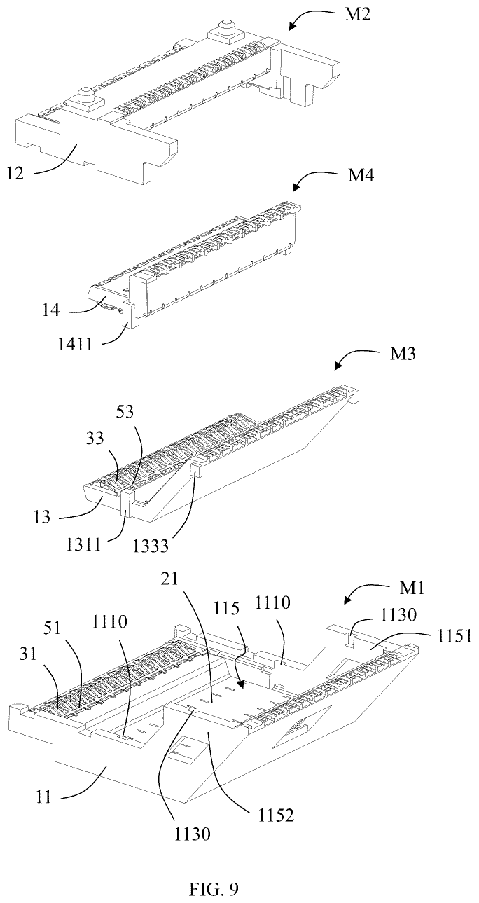

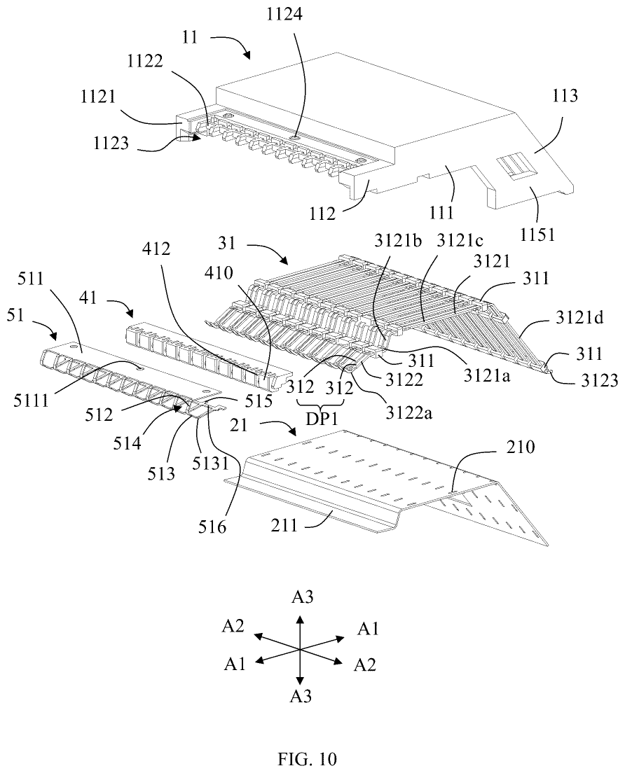

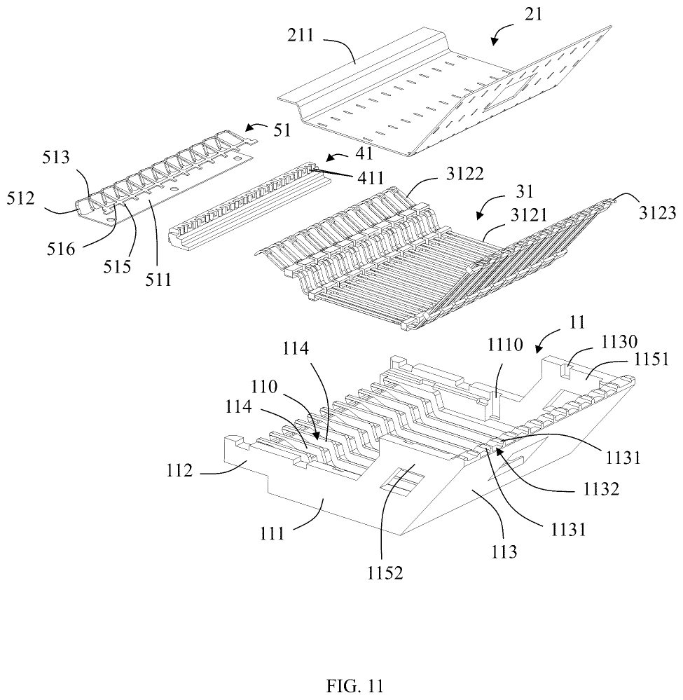

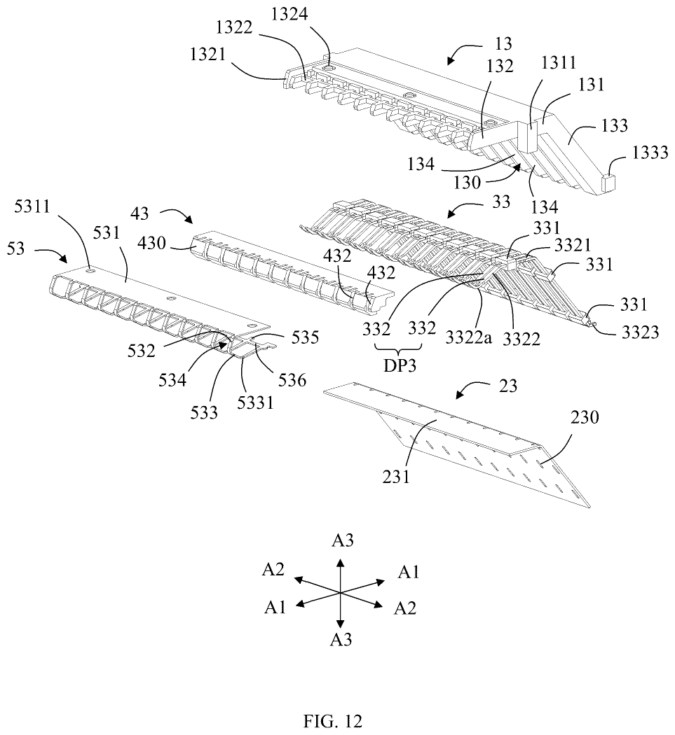

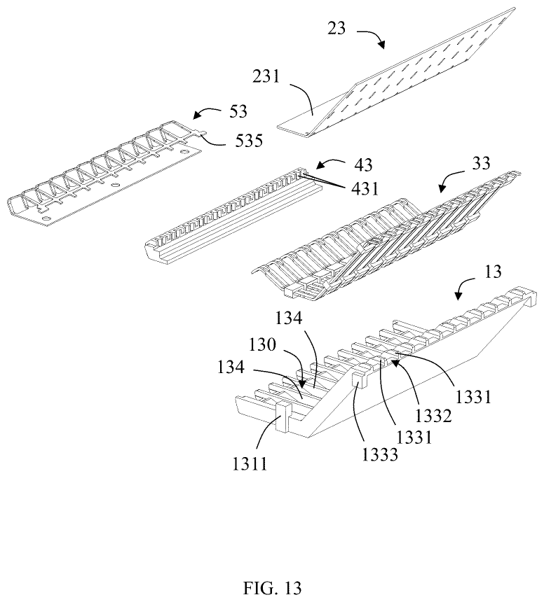

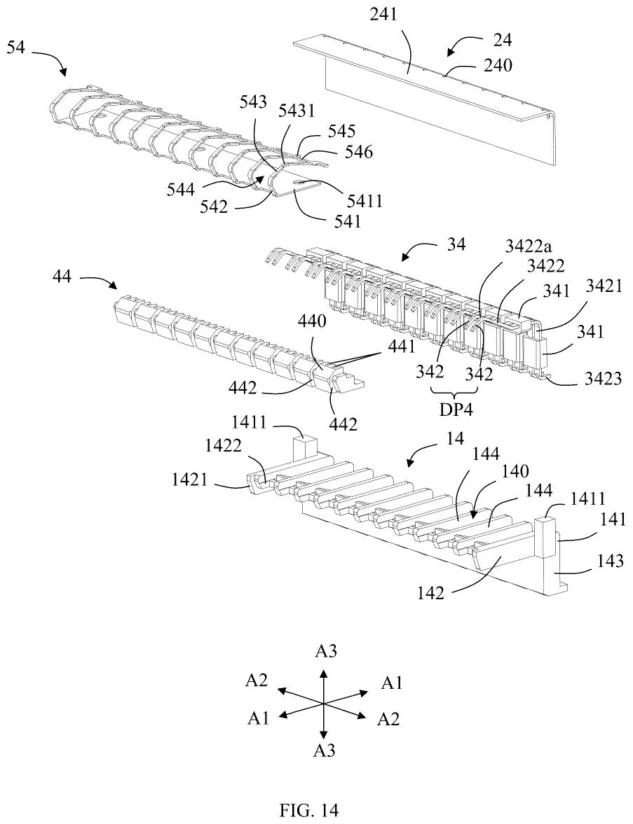

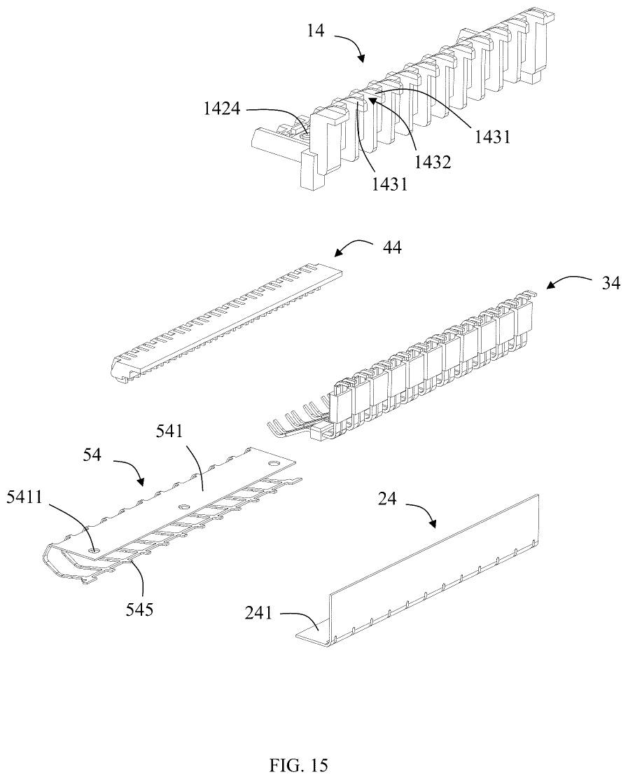

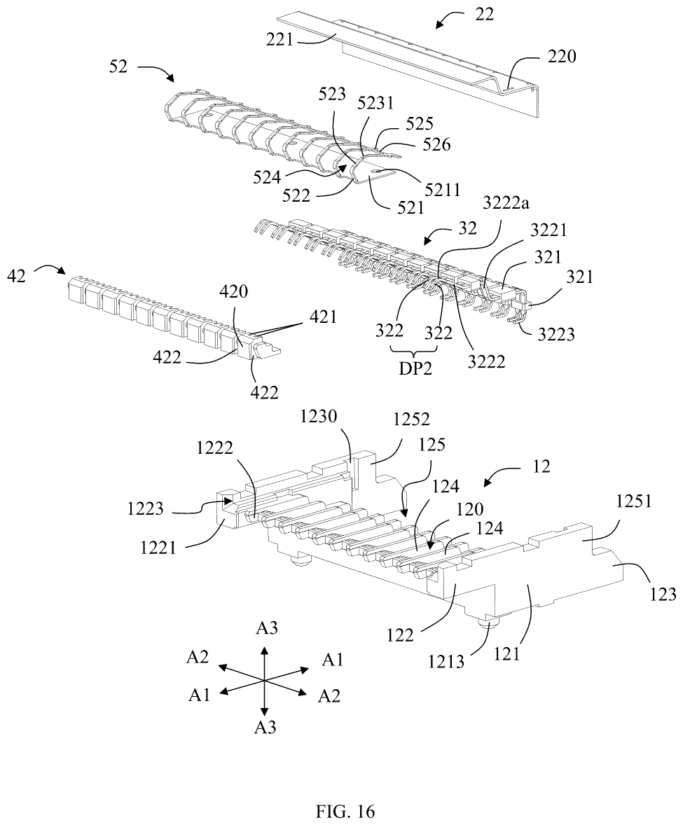

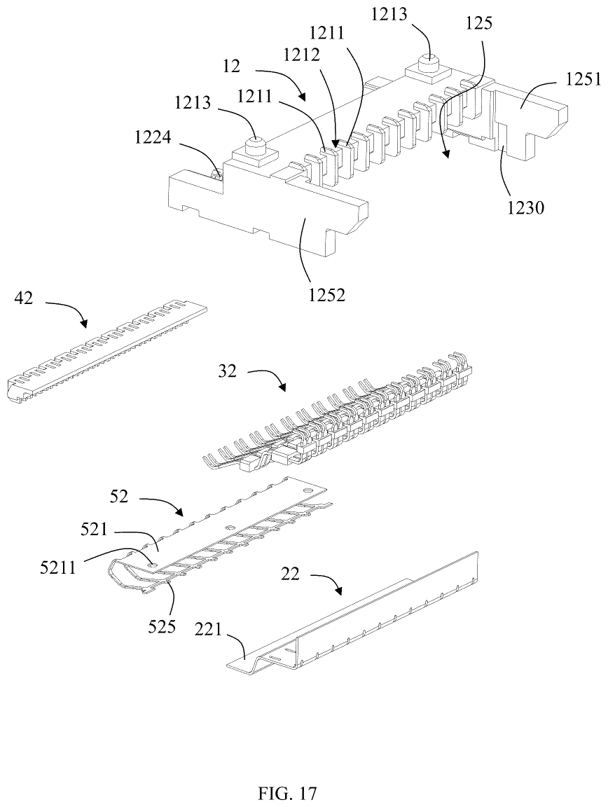

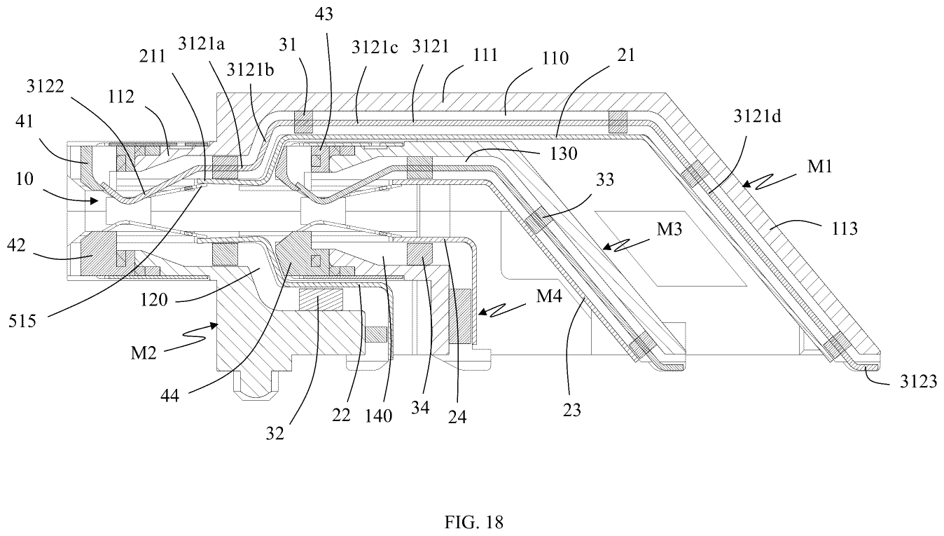

Referring to FIG. 1 to FIG. 5, the present disclosure discloses a connector assembly, which includes a circuit board 200, an electrical connector 100 installed on the circuit board 200 and a mating module 300 configured to mate with the electrical connector 100. In an embodiment of the present disclosure, the mating module 300 is a circuit board. Of course, in other embodiments, the mating module 300 may also be a mating connector.

The mating module 300 has a tongue plate 301 for being inserted into the electrical connector 100. The tongue plate 301 is provided with a plurality of conductive pads 302 on two opposite surfaces thereof.

The circuit board 200 includes a plurality of soldering pads. The soldering pads include a plurality of first soldering pads 201, a plurality of second soldering pads 202, a plurality of third soldering pads 203 and a plurality of fourth soldering pads that are spaced apart along a first direction A1-A1 (for example, a front-rear direction). The first soldering pads 201 are arranged in a first row L1 along a second direction A2-A2 (for example, a left-right direction). The second soldering pads 202 are arranged in a second row L2 along the second direction A2-A2. The third soldering pads 203 are arranged in a third row L3 along the second direction A2-A2. The fourth soldering pads 204 are arranged in a fourth row L4 along the second direction A2-A2. The first row L1, the second row L2, the third row L3 and the fourth row L4 are parallel to one another. Besides, the circuit board 200 further defines a plurality of mounting holes 205 extending through the circuit board 200 along a third direction A3-A3 (for example, a top-bottom direction).

In the illustrated embodiment of the present disclosure, the electrical connector 100 includes a first terminal module M1, a second terminal module M2, a third terminal module M3 and a fourth terminal module M4.

The first terminal module M1 includes a first conductive housing 11, a first conductive cover plate 21 disposed on an inner side of the first conductive housing 11, a plurality of first terminal assemblies 31 installed to the inner side of the first conductive housing 11 and covered by the first conductive cover plate 21, a first insulating block 41 fixed to the first conductive housing 11, and a first ground plate 51 fixed to the first conductive housing 11 and in contact with the first conductive cover plate 21.

In an embodiment of the present disclosure, the first conductive housing 11 is made of a metal material and has an integrated structure. The first conductive housing 11 includes a first main body portion 111, a first mating portion 112 extending forwardly from one end (for example, a front end) of the first main body portion 111, and a first extension portion 113 extending backwardly from another end (for example, a rear end) of the first main body portion 111. In the illustrated embodiment of the present disclosure, the first mating portion 112, the first main body portion 111 and the first extension portion 113 are integrally formed to improve the shielding effect. Specifically, in the illustrated embodiment of the present disclosure, the first mating portion 112 and the first main body portion 111 are in a step-shaped configuration, in which an upper surface of the first mating portion 112 is lower than an upper surface of the first main body portion 111. The first extension portion 113 extends obliquely backward and downward from the first main body portion 111.

In the illustrated embodiment of the present disclosure, the first conductive housing 11 includes a plurality of first terminal installation slots 110 located on an inner surface (for example, a lower surface) thereof, and a plurality of first partition walls 114 each separating two adjacent first terminal installation slots 110. Specifically, the first terminal installation slots 110 are provided on a lower surface of the first mating portion 112, a lower surface of the first main body portion 111 and a lower surface of the first extension portion 113. In other words, each first terminal installation slot 110 extends from the lower surface of the first mating portion 112 all the way to the lower surface of the first extension portion 113.

The first mating portion 112 includes a first end surface 1121 (for example, a front end surface), a first mounting groove 1122 disposed adjacent to the first end surface 1121, a first mating slot 1123 extending through the first end surface 1121, and a plurality of first positioning posts 1124 protruding upwardly.

A plurality of first positioning slots 1110 are provided on two sides of the first main body portion 111 to mate with the third terminal module M3.

The first main body portion 111 and the first extension portion 113 together form a first receiving space 115 for accommodating the third terminal module M3. The first extension portion 113 includes a first side wall 1151 and a second side wall 1152 which are located on two sides of the first receiving space 115, respectively. A plurality of first holding slots 1130 are provided on two sides of the first extension portion 113, respectively, to mate with the third terminal module M3. Besides, a bottom end of the first extension portion 113 further includes a plurality of first shielding protrusions 1131 and a plurality of first receiving grooves 1132 of which each is located between two adjacent first shielding protrusions 1131.

The first conductive cover plate 21 is located on the inner side of the first conductive housing 11 and at least partially covers the first terminal installation slots 110. In the illustrated embodiment of the present disclosure, the first conductive cover plate 21 is made of a metal material to improve the shielding effect. At least part of the first terminal installation slot 110 is fully surrounded by the first conductive housing 11 and the first conductive cover plate 21 so that a better shielding is formed for the first terminal assembly 31 located in the first terminal installation slot 110, thereby improving the quality of signal transmission. In the illustrated embodiment of the present disclosure, a shape of the first conductive cover plate 21 matches the inner surface of the first conductive housing 11 so that the first conductive cover plate 21 can fit better on the inner side of the first conductive housing 11. In an embodiment of the present disclosure, the first conductive cover plate 21 is fixed to the inner side of the first conductive housing 11 by soldering or welding. Specifically, the first conductive cover plate 21 is provided with a plurality of first openings 210. The first openings 210 correspond to the first shielding protrusions 1131 to facilitate soldering or welding. In the illustrated embodiment of the present disclosure, the first conductive cover plate 21 generally covers the lower surface of the first main body portion 111 and the inner surface of the first extension portion 113. The first conductive cover plate 21 does not completely cover the lower surface of the first mating portion 112. In the illustrated embodiment of the present disclosure, the first conductive cover plate 21 is provided with a first protruding portion 211 that protrudes below the first mating portion 112. The first protruding portion 211 is generally flat-shaped.

The first terminal assembly 31 includes a plurality of first insulating fixing blocks 311 and a plurality of first signal terminals 312 fixed to the first insulating fixing blocks 311. The first terminal assembly 31 is at least partially installed in the first terminal installation slot 110. Each first signal terminal 312 includes a first middle portion 3121, a first signal elastic arm portion 3122 extending from one end (for example, a front end) of the first middle portion 3121, and a first tail portion 3123 extending from another end (for example, a rear end) of the first middle portion 3121. The first insulating fixing blocks 311 are at least fixed on the first middle portion 3121 and are received in the first terminal installation slot 110. The first signal elastic arm portion 3122 at least partially protrudes into the first mating slot 1123. Specifically, the first signal flare arm portion 3122 includes a first signal contact portion 3122a configured to contact the conductive pad 302 of the mating module 300. The first signal terminals 312 do not contact the first conductive housing 11 nor the first conductive cover plate 21 in order to prevent short circuit.

In the illustrated embodiment of the present disclosure, the first conductive housing 11 covers the first signal flare arm portion 3122, the middle portion 3121 and the first tail portion 3123 of the first signal terminal 312 along a length direction of the first signal terminal 312. Therefore, most of the first signal terminal 312 is covered along its entire length direction, thereby improving the shielding effect. For example, the first conductive housing 11 covers at least 90% of the first signal elastic arm portion 3122, at least 90% of the first middle portion 3121 and at least 90% of the first tail portion 3123 of the first signal terminal 312 along the length direction of the first signal terminal 312. Preferably, the first conductive housing 11 completely covers the first signal flare arm portion 3122, the first middle portion 3121 and the first tail portion 3123 of the first signal terminal 312 along the length direction of the first signal terminal 312. Therefore, a full coverage is achieved along the entire length direction of the first signal terminal 312, thereby further improving the shielding effect.

In the illustrated embodiment of the present disclosure, two first signal terminals 312 are provided of the first terminal assembly 31 and form a first differential pair DP1 so as to increase the signal transmission rate. The plurality of first insulating fixing blocks 311 are formed on the two first signal terminals 312. The plurality of first insulating fixing blocks 311 are disposed at intervals along the length direction of the first signal terminal 312. After the first insulating fixing blocks 311 are installed in the first terminal installation slot 110, the first signal terminals 312 are suspended in the first terminal installation slot 110, thereby avoiding contact the first conductive housing 11 to prevent short circuit. Of course, it is understandable to those skilled in the art that the number and shape of the first insulating fixing blocks 311 can be flexibly adjusted as needed, which will not be described in detail in the present disclosure.

The shape of the first signal terminal 312 matches the first terminal installation slot 110. Specifically, in the illustrated embodiment of the disclosure, the first middle portion 3121 includes a first front end portion 3121a connected to the first signal flare arm portion 3122, a first inclined portion 3121b extending upwardly and backwardly from a rear end of the first front end portion 3121a, a first straight portion 3121c extending backwardly from a rear end of the first inclined portion 3121b, and a second inclined portion 3121d extending downwardly and backwardly from a rear end of the first straight portion 3121c. The first tail portion 3123 is connected to the second inclined portion 3121d. The first tail portion 3123 is configured to be electrically connected to the first soldering pad 201 of the circuit board 200. For example, the first tail portion 3123 is fixed to the first soldering pad 201 by soldering or welding. It is understandable to those skilled in the art that by providing the first inclined portion 3121b to transition the first straight portion 3121c upwardly, a space can be provided for forming the first receiving space 115. In the illustrated embodiment of the present disclosure, the first tail portions 3123 of the first signal terminals 312 in the first differential pair DP1 are located in the first receiving groove 1132. The first differential pair DP1 is shielded by the first shielding protrusions 1131 on two sides thereof so as to reduce the probability of crosstalk with other first signal terminals 312 during signal transmission and improve the quality of signal transmission.

The first conductive cover plate 21 is bent in such a manner to be adapted to the first front end portion 3121a, the first inclined portion 3121b, the first straight portion 3121c and the second inclined portion 3121d to avoid contact with the first middle portion 3121 of the first signal terminal 312.

The first insulating block 41 mates with the first mating portion 112 of the first conductive housing 11. In one embodiment of the present disclosure, the first insulating block 41 is insert-molded in the first mounting groove 1122 of the first mating portion 112 so that the first insulating block 41 and the first mating portion 112 can be tightly fixed together. Of course, in other embodiments of the present disclosure, the first insulating block 41 can be fixed in the first installation groove 1122 of the first mating portion 112 in other ways, for example, by assembly.

The first insulating block 41 includes a first front end surface 410 which is flush with the first end surface 1121 of the first mating portion 112. Besides, the first insulating block 41 further includes a plurality of first slits 411 and a plurality of first slots 412. The first signal arm portion 3122 of the first signal terminal 312 at least partially extends into the first slit 411. By disposing the first insulating block 41 adjacent to the front end of the first mating slot 1123, on the one hand, protection can be provided for the first signal elastic arm portion 3122 of the first signal terminal 312, and on the other hand, it also reduces the risk of the first signal terminal 312 being touched by other components and causing a short circuit.

The first ground plate 51 is made of a metal material. In the illustrated embodiment of the present disclosure, the first ground plate 51 is generally U-shaped, and includes a first fixing portion 511 installed on the first mating portion 112, a plurality of first spacing arms 512 extending forwardly and downwardly from the first fixing portion 511, a plurality of first ground elastic arm portions 513 extending backwardly and downwardly from the first spacing arms 512. In the illustrated embodiment of the present disclosure, the first spacing arms 512 are spaced apart along the second direction A2-A2. The first ground elastic arm portions 513 are spaced apart along the second direction A2-A2. The first ground elastic arm portions 513 is located below the first fixing portion 511. The first ground elastic arm portion 513 includes a first ground contact portion 5131 configured to contact the conductive pad 302 of the mating module 300.

Specifically, the first fixing portion 511 includes a plurality of first positioning holes 5111 that match the first positioning posts 1124. The first fixing portion 511 is in contact with the upper surface of the first mating portion 112. The first fixing portion 511 is located outside the first mating slot 1123. With this arrangement, the first fixing portion 511 can be less restricted by the first mating slot 1123, so that its grounding area can be adjusted more flexibly to improve the grounding effect.

The first ground plate 51 includes a plurality of first openings 514 of which each is located between two adjacent first spacing arms 512. The first insulating block 41 is at least partially located in the first opening 514. In other words, the first spacing arm 512 is at least partially located in the first slot 412.

The first ground elastic arm portion 513 extends along the first insulating block 41 into the first mating slot 1123. The first ground contact portion 5131 is located beside the first signal contact portions 3122a of the first differential pair DP1 along the second direction A2-A2 to improve the shielding effect.

The first ground plate 51 further includes a plurality of first contact portions 515 extending from the first ground elastic arm portions 513 and a first connecting portion 516 connecting the first contact portions 515.

The first ground plate 51 is in contact with at least one of the first conductive cover plate 21 and the first conductive housing 11 to improve the shielding effect. In the illustrated embodiment of the present disclosure, the first ground plate 51 and the first conductive cover plate 21 are two components but are in contact with each other. Specifically, the first contact portion 515 is in contact with the first protruding portions 211 of the first conductive cover plate 21. Of course, it is understandable to those skilled in the art that in other embodiments of the present disclosure, the first ground plate 51 and the first conductive cover plate 21 can also be integrally formed into one piece.

The second terminal module M2 includes a second conductive housing 12, a second conductive cover plate 22 installed to an inner side of the second conductive housing 12, a plurality of second terminal assemblies 32 installed the inner side of the second conductive housing 12 and covered by the second conductive cover plate 22, a second insulating block 42 fixed to the second conductive housing 12, and a second ground plate 52 fixed to the second conductive housing 12 and in contact with the second conductive cover plate 22.

In one embodiment of the present disclosure, the second conductive housing 12 is made of a metal material and has an integrated structure. The second conductive housing 12 includes a second main body portion 121, a second mating portion 122 extending forwardly from one end (for example, a front end) of the second main body portion 121, and a second extension portion 123 extending backwardly from another end (for example, a rear end) of the second main body portion 121. In the illustrated embodiment of the present disclosure, the second mating portion 122, the second main body portion 121 and the second extension portion 123 are integrally formed to improve the shielding effect. Specifically, in the illustrated embodiment of the present disclosure, the second mating portion 122 and the second main body portion 121 are in a step-shaped configuration. A lower surface of the second mating portion 122 is higher than a lower surface of the second main body portion 121. The second extension portion 123 extends backwardly from two sides of the second main body portion 121.

In the illustrated embodiment of the present disclosure, the second conductive housing 12 includes a plurality of second terminal installation slots 120 located on an inner surface (for example, an upper surface) thereof, and a plurality of second partition walls 124 each separating two adjacent second terminal installation slots 120. Specifically, the second terminal installation slots 120 are provided on an upper surface of the second mating portion 122 and an upper surface of the second main body portion 121. In other words, the second terminal installation slot 120 extends from the upper surface of the second mating portion 122 all the way to the upper surface of the second extension portion 123.

The second mating portion 122 includes a second end surface 1221 (for example, a front end surface), a plurality of second mounting grooves 1222 disposed adjacent to the second end surface 1221, a second mating slot 1223 extending through the second end surface 1221, and a plurality of second positioning posts 1224 protruding downwardly.

The second main body portion 121 and the second extension portion 123 together form a second receiving space 125 for receiving the fourth terminal module M4. The second extension portion 123 includes a third side wall 1251 and a fourth side wall 1252 located on two sides of the second receiving space 125, respectively. A plurality of second positioning slots 1230 are provided on two sides of the second extension portion 123, respectively, to mate with the fourth terminal module M4. Besides, a bottom of the second main body portion 121 further includes a plurality of second shielding protrusions 1211 and a plurality of second receiving grooves 1212 of which each is located between two adjacent second shielding protrusions 1211, and a plurality of mounting posts 1213 protruding downwardly. The mounting posts 1213 are used to be inserted into the mounting holes 205 of the circuit board 200.

The second conductive cover plate 22 is located on the inner side of the second conductive housing 12 and at least partially covers the second terminal installation slots 120. In the illustrated embodiment of the present disclosure, the second conductive cover plate 22 is made of a metal material to improve the shielding effect. At least part of the second terminal installation slot 120 is surrounded by the second conductive housing 12 and the second conductive cover plate 22. Therefore, a better shielding is formed for the second terminal assembly 32 located in the second terminal installation slot 120 to improve the quality of signal transmission. In the illustrated embodiment of the present disclosure, the shape of the second conductive cover plate 22 matches the inner surface of the second conductive housing 12 so that the second conductive cover plate 22 can fit better on the inner side of the second conductive housing 12. The second conductive cover plate 22 is fixed to the inner side of the second conductive housing 12 by soldering or welding. Specifically, the second conductive cover plate 22 includes a plurality of second openings 220. The second openings 220 correspond to the second shielding protrusions 1211 to facilitate soldering or welding. In the illustrated embodiment of the present disclosure, the second conductive cover plate 22 generally covers the upper surface of the second main body portion 121 and the upper surface of the second extension portion 123. The second conductive cover plate 22 does not completely cover the upper surface of the second mating portion 122. In the illustrated embodiment of the present disclosure, the second conductive cover plate 22 is provided with a second protruding portion 221 that protrudes above the second mating portion 122. The second protruding portion 221 is generally flat-shaped.

The second terminal assembly 32 includes a plurality of second insulating fixing blocks 321 and a plurality of second signal terminals 322 fixed to the second insulating fixing blocks 321. The second terminal assembly 32 is at least partially installed in the second terminal installation slot 120. Each second signal terminal 322 includes a second middle portion 3221, a second signal elastic arm portion 3222 extending from one end (for example, a front end) of the second middle portion 3221, and a second tail portion 3223 extending from another end (for example, a rear end) of the second middle portion 3221. The second insulating fixing blocks 321 are at least fixed to the second middle portion 3221 and received in the second terminal installation slot 120. The second signal elastic arm portion 3222 at least partially protrudes into the second mating slot 1223. Specifically, the second signal flare arm portion 3222 includes a second signal contact portion 3222a configured to contact the conductive pad 302 of the mating module 300. The second signal terminals 322 do not contact the second conductive housing 12 nor the second conductive cover plate 22 to prevent short circuit.

In the illustrated embodiment of the present disclosure, the second conductive housing 12 covers the second signal flare arm portion 3222, the second middle portion 3221 and the second tail portion 3223 of the second signal terminal 322 along a length direction of the second signal terminal 322. Therefore, most of the second signal terminal 322 is covered along its entire length direction, thereby improving the shielding effect. For example, the second conductive housing 12 covers at least 90% of the second signal flare arm portion 3222, at least 90% of the second middle portion 3221 and at least 90% of the second tail portion 3223 of the second signal terminal 322 along the length direction of the second signal terminal 322. Preferably, the second conductive housing 12 completely covers the second signal flare arm portion 3222, the second middle portion 3221 and the second tail portion 3223 of the second signal terminal 322 along the length direction of the second signal terminal 322. Therefore, a full coverage is achieved along the entire length direction of the second signal terminal 322, thereby further improving the shielding effect.

In the illustrated embodiment of the present disclosure, two second signal terminals 322 are provided in the second terminal assembly 32 and form a second differential pair DP2 to increase the signal transmission rate. The plurality of second insulating fixing blocks 321 are formed on the two second signal terminals 322. The plurality of second insulating fixing blocks 321 are spaced apart along the length direction of the second signal terminal 322. After the second insulating fixing blocks 321 are installed in the second terminal installation slot 120, the second signal terminals 322 are suspended in the second terminal installation slot 120, thereby avoiding contact the second conductive housing 12 to prevent short circuit. Of course, it is understandable to those skilled in the art that the number and shape of the second insulating fixing blocks 321 can be flexibly adjusted as needed, which will not be described in detail in the present disclosure.

The shape of the second signal terminal 322 matches the second terminal installation slot 120. The second tail portion 3223 is configured to be electrically connected to the second soldering pad 202 of the circuit board 200. For example, the second tail portion 3223 is fixed to the second soldering pad 202 by soldering or welding. In the illustrated embodiment of the present disclosure, the second tail portions 3223 of the second signal terminals 322 in the second differential pair DP2 are located in the second receiving groove 1212. The second tail portions 3223 of the second signal terminals 322 in the second differential pair DP2 are shielded by the second shielding protrusions 1211 on two sides thereof to reduce the probability of crosstalk with other second signal terminals 322 when transmitting signals, thereby improving the quality of signal transmission.

The second insulating block 42 mates with the second mating portion 122 of the second conductive housing 12. In one embodiment of the present disclosure, the second insulating block 42 is insert-molded in the second mounting grooves 1222 of the second mating portion 122 so that the second insulating block 42 and the second mating portion 122 are tightly fixed together. Of course, in other embodiments of the present disclosure, the second insulating block 42 can be fixed in the second installation grooves 1222 of the second mating portion 122 in other ways, for example, by assembly.

The second insulating block 42 includes a second front end surface 420 which is flush with the second end surface 1221 of the second mating portion 122. Besides, the second insulating block 42 is further provided with a plurality of second slits 421 and a plurality of second slots 422. The second signal arm portion 3222 of the second signal terminal 322 at least partially extends into the second slit 421. By disposing the second insulating block 42 adjacent to the front end of the second mating slot 1223, on the one hand, the second signal elastic arm portion 3222 of the second signal terminal 322 can be protected; and on the other hand, it also reduces the risk of the second signal terminal 322 being touched by other components and causing a short circuit.

The second ground plate 52 is made of a metal material. In the illustrated embodiment of the present disclosure, the second ground plate 52 is generally U-shaped, and includes a second fixing portion 521 installed on the second mating portion 122, a plurality of second spacing arms 522 extending forwardly and upwardly from the second fixing portion 521, and a plurality of second ground elastic arm portions 523 extending backwardly and upwardly from the second spacing arms 522. In the illustrated embodiment of the present disclosure, the second spacing arms 522 are spaced apart along the second direction A2-A2. The second ground elastic arm portions 523 are spaced apart along the second direction A2-A2. The second ground elastic arm portions 523 are located below the second fixing portion 521. The second ground elastic arm portion 523 includes a second ground contact portion 5231 configured to contact the conductive pad 302 of the mating module 300.

Specifically, the second fixing portion 521 defines a plurality of second positioning holes 5211 that mate with the second positioning posts 1224. The second fixing portion 521 is in contact with the lower surface of the second mating portion 122. The second fixing portion 521 is located outside the second mating slot 1223. With this arrangement, the second fixing portion 521 can be less restricted by the second mating slot 1223, so that its grounding area can be adjusted more flexibly to improve the grounding effect.

The second ground plate 52 includes a plurality of second openings 524 of which each is located between two adjacent second spacing arms 522. The second insulating block 42 is at least partially located in the second opening 524. In other words, the second spacing arm 522 is at least partially located in the second slot 422.

The second ground elastic arm portion 523 extends along the second insulating block 42 into the second mating slot 1223. The second ground contact portion 5231 is located beside the second signal contact portions 3222a of the second differential pair DP2 along the second direction A2-A2 to improve the shielding effect.

The second ground plate 52 further includes a plurality of second contact portions 525 extending from the second ground elastic arm portions 523 and a second connecting portion 526 connecting the second contact portions 525.

The second ground plate 52 is in contact with at least one of the second conductive cover plate 22 and the second conductive housing 12 to improve the shielding effect. In the illustrated embodiment of the present disclosure, the second ground plate 52 and the second conductive cover plate 22 are two components and are in contact with each other. Specifically, the second contact portion 525 is in contact with the second protruding portion 221 of the second conductive cover plate 22. Of course, it is understandable to those skilled in the art that in other embodiments of the present disclosure, the second ground plate 52 and the second conductive cover plate 22 can also be integrally formed into one piece.

In the illustrated embodiment of the present disclosure, the first conductive housing 11 of the first terminal module M1 is in contact with the second conductive housing 12 of the second terminal module M2 to form a mating slot 10 between the first conductive housing 11 and the second conductive housing 12. In the illustrated embodiment of the present disclosure, the mating slot 10 includes the first mating slot 1123 and the second mating slot 1223. In an embodiment of the present disclosure, the first conductive housing 11 of the first terminal module M1 and the second conductive housing 12 of the second terminal module M2 are fixed together by soldering or welding.

The first signal contact portions 3122a and the first ground contact portions 5131 of the first terminal module M1 protrude into the mating slot 10 from one side (for example, from a top-to-bottom direction), and the second signal contact portions 3222a and the second ground contact portions 5231 of the second terminal module M2 protrude into the mating slot 10 from an opposite side (for example, from a bottom-to-top direction). The mating slot 10 is configured to accommodate the mating module 300. The conductive pads 302 of the mating module 300 are in contact with the first signal contact portions 3122a, the first ground contact portions 5131, the second signal contact portions 3222a, and the second ground contact portions 5231, respectively.

The third terminal module M3 includes a third conductive housing 13, a third conductive cover plate 23 installed on an inner side of the third conductive housing 13, a plurality of third terminal assemblies 33 installed the inner side of the third conductive housing 13 and covered by the third conductive cover plate 23, a third insulating block 43 fixed to the third conductive housing 13, and a third ground plate 53 fixed to the third conductive housing 13 and in contact with the third conductive cover plate 23.

In one embodiment of the present disclosure, the third conductive housing 13 is made of a metal material and has an integrated structure. The third conductive housing 13 includes a third main body portion 131, a third mating portion 132 extending forwardly from one end (for example, a front end) of the third main body portion 131, and a third extension portion 133 extending backwardly from another end (for example, a rear end) of the third main body portion 131. In the illustrated embodiment of the present disclosure, the third mating portion 132, the third main body portion 131 and the third extension portion 133 are integrally formed to improve the shielding effect. Specifically, in the illustrated embodiment of the present disclosure, the third extension portion 133 extends obliquely backward and downward from the third main body portion 131.

In the illustrated embodiment of the present disclosure, the third conductive housing 13 includes a plurality of third terminal installation slots 130 located on an inner surface (for example, a lower surface) thereof, and a plurality of third partition walls 134 each separating two adjacent third terminal installation slots 130. Specifically, the third terminal installation slots 130 are provided on a lower surface of the third mating portion 132, a lower surface of the third main body portion 131 and a lower surface of the third extension portion 133. In other words, the third terminal installation slot 130 extends all the way from the lower surface of the third mating portion 132 to the lower surface of the third extension portion 133.

The third mating portion 132 includes a third end surface 1321 (for example, a front end surface), a plurality of third installation grooves 1322 disposed adjacent to the third end surface 1321, and a plurality of third positioning posts 1324 protruding upwardly.

A plurality of first positioning protrusions 1311 for being inserted into the first positioning slots 1110 are provided on two sides of the third main body portion 131, respectively. A plurality of first holding posts 1333 for being inserted into the first holding slots 1130 are provided on two sides of the third extension portion 133, respectively. Besides, a bottom end of the third extension portion 133 further includes a plurality of third shielding protrusions 1331 and a plurality of third receiving grooves 1332 of which each is located between two adjacent third shielding protrusions 1331.

The third conductive cover plate 23 is located on the inner side of the third conductive housing 13 and at least partially covers the third terminal installation slots 130. In the illustrated embodiment of the present disclosure, the third conductive cover plate 23 is made of a metal material to improve the shielding effect. At least part of the third terminal installation slot 130 is surrounded by the third conductive housing 13 and the third conductive cover plate 23. Therefore, a better shielding is formed for the third terminal assembly 33 located in the third terminal installation slot 130 to improve the quality of signal transmission. In the illustrated embodiment of the present disclosure, the shape of the third conductive cover plate 23 is adapted to the inner surface of the third conductive housing 13, which allows the third conductive cover plate 23 to fit better on the inner side of the third conductive housing 13. The third conductive cover plate 23 is fixed to the inner side of the third conductive housing 13 by soldering or welding. Specifically, the third conductive cover plate 23 defines a plurality of third openings 230. The third openings 230 correspond to the third shielding protrusions 1331 to facilitate soldering or welding. In the illustrated embodiment of the present disclosure, the third conductive cover plate 23 generally covers a lower surface of the third main body portion 131 and an inner surface of the third extension portion 133. The third conductive cover plate 23 does not completely cover the lower surface of the third mating portion 132. In the illustrated embodiment of the disclosure, the third conductive cover plate 23 is provided with a third protruding portion 231 that protrudes below the third mating portion 132. The third protruding portion 231 is generally flat-shaped.

The third terminal assembly 33 includes a plurality of third insulating fixing blocks 331 and a plurality of third signal terminals 332 fixed to the third insulating fixing blocks 331. The third terminal assembly 33 is at least partially installed in the third terminal installation slot 130. The third signal terminal 332 includes a third middle portion 3321, a third signal elastic arm portion 3322 extending from one end (for example, a front end) of the third middle portion 3321, and a third tail portion 3323 extending from another end (for example, a rear end) of the third middle portion 3321. The third insulating fixing blocks 331 are at least fixed on the third middle portion 3321 and are received in the third terminal installation slot 130. The third signal elastic arm portion 3322 at least partially protrudes into the first mating slot 1123. Specifically, the third signal flare arm portion 3322 includes a third signal contact portion 3322a configured to contact the conductive pad 302 of the mating module 300. The third signal terminals 332 do not contact the third conductive housing 13 nor the third conductive cover plate 23 to prevent short circuit.

In the illustrated embodiment of the present disclosure, the third conductive housing 13 covers the third signal flare arm portion 3322, the third middle portion 3321 and the third tail portion 3323 of the third signal terminal 332 along a length direction of the third signal terminal 332. Therefore, most of the third signal terminal 332 is covered along its entire length direction, thereby improving the shielding effect. For example, the third conductive housing 13 covers at least 90% of the third signal flare arm portion 3322, at least 90% of the third middle portion 3321 and at least 90% of the third tail portion 3323 of the third signal terminal 332 along the length direction of the third signal terminal 332. Preferably, the third conductive housing 13 completely covers the third signal flare arm portion 3322, the third middle portion 3321 and the third tail portion 3323 of the third signal terminal 332 along the length direction of the third signal terminal 332. Therefore, a full coverage is achieved along the entire length direction of the third signal terminal 332, thereby further improving the shielding effect.

In the illustrated embodiment of the present disclosure, two third signal terminals 332 are provided in the third terminal assembly 33, and form a third differential pair DP3 to increase the signal transmission rate. The plurality of third insulating fixing blocks 331 are formed on the two third signal terminals 332. The plurality of third insulating fixing blocks 331 are arranged at intervals along the length direction of the third signal terminal 332. After the third insulating fixing blocks 331 are installed in the third terminal installation slot 130, the third signal terminal 332 is suspended in the third terminal installation slot 130, thereby avoiding contact the third conductive housing 13 to prevent short circuit. Of course, it is understandable to those skilled in the art that the number and shape of the third insulating fixing blocks 331 can be flexibly adjusted as needed, which will not be described in detail in the present disclosure.

The shape of the third signal terminal 332 matches the third terminal installation slot 130. Specifically, in the illustrated embodiment of the present disclosure, the third tail portion 3323 is configured to be electrically connected to the third soldering pad 203 of the circuit board 200. For example, the third tail portion 3323 is fixed to the third soldering pad 203 by soldering or welding. In the illustrated embodiment of the present disclosure, the third tail portions 3323 of the third signal terminals 332 in the third differential pair DP3 are located in the third receiving groove 1332. The third tail portions 3323 of the third signal terminals 332 in the third differential pair DP3 are shielded by the third shielding protrusions 1331 on two sides thereof to reduce the probability of crosstalk with other third signal terminals 332 when transmitting signals, thereby improving the quality of signal transmission.

The third insulating block 43 mates with the third mating portion 132 of the third conductive housing 13. In one embodiment of the present disclosure, the third insulating block 43 is insert-molded in the third mounting grooves 1322 of the third mating portion 132 so that the third insulating block 43 and the third mating portion 132 are tightly fixed together. Of course, in other embodiments of the present disclosure, the third insulating block 43 can be fixed in the third installation grooves 1322 of the third mating portion 132 in other ways, for example, by assembly.

The third insulating block 43 includes a third front end surface 430 which is flush with the third end surface 1321 of the third mating portion 132. Besides, the third insulating block 43 further includes a plurality of third slits 431 and a plurality of third slots 432. The third signal arm portion 3322 of the third signal terminal 332 at least partially extends into the third slit 431. By disposing the third insulating block 43 adjacent to the front end of the first mating slot 1123, on the one hand, protection can be provided for the third signal elastic arm portion 3322 of the third signal terminal 332, and on the other hand, it also reduces the risk of the third signal terminal 332 being touched by other components and causing a short circuit.

The third ground plate 53 is made of a metal material. In the illustrated embodiment of the present disclosure, the third ground plate 53 is generally U-shaped, and includes a third fixing portion 531 installed on the third mating portion 132, a plurality of third spacing arms 532 extending forwardly and downwardly from the third fixing portion 531, and a plurality of third ground elastic arm portions 533 extending backwardly and downwardly from the third spacing arms 532. In the illustrated embodiment of the present disclosure, the third spacing arms 532 are spaced apart along the second direction A2-A2. The third ground elastic arm portions 533 are arranged at intervals along the second direction A2-A2. The third ground elastic arm portions 533 are located below the third fixing portion 531. The third ground elastic arm portion 533 includes a third ground contact portion 5331 configured to contact the conductive pad 302 of the mating module 300.

Specifically, the third fixing portion 531 defines a plurality of third positioning holes 5311 that mate with the third positioning posts 1324. The third fixing portion 531 is in contact with the upper surface of the third mating portion 132. The third fixing portion 531 is located outside the first mating slot 1123. With this arrangement, the third fixing portion 531 can be less restricted by the first mating slot 1123, so that its grounding area can be adjusted more flexibly to improve the grounding effect.

The third ground plate 53 includes a plurality of third openings 534 of which each is located between two adjacent third spacing arms 532. The third insulating block 43 is at least partially located in the third opening 534. In other words, the third spacing arm 532 is at least partially located in the third slot 432.

The third ground elastic arm portion 533 extends along the third insulating block 43 into the first mating slot 1123. The third ground contact portion 5331 is located beside the third signal contact portions 3322a of the third differential pair DP3 along the second direction A2-A2 to improve the shielding effect.

The third ground plate 53 further includes a plurality of third contact portions 535 extending from the third ground elastic arm portions 533, and a third connecting portion 536 connecting the third contact portions 535.

The third ground plate 53 is in contact with at least one of the third conductive cover plate 23 and the third conductive housing 13 to improve the shielding effect. In the illustrated embodiment of the present disclosure, the third ground plate 53 and the third conductive cover plate 23 are two components and are in contact with each other. Specifically, the third contact portion 535 is in contact with the third protruding portion 231 of the third conductive cover plate 23. Of course, it is understandable to those skilled in the art that in other embodiments of the present disclosure, the third ground plate 53 and the third conductive cover plate 23 can also be integrally formed into one piece.

The fourth terminal module M4 includes a fourth conductive housing 14, a fourth conductive cover plate 24 installed on an inner side of the fourth conductive housing 14, a plurality of fourth terminal assemblies 34 installed in the inner side of the fourth conductive housing 14 and covered by the fourth conductive cover plate 24, a fourth insulating block 44 fixed to the fourth conductive housing 14, and a fourth ground plate 54 fixed to the fourth conductive housing 14 and in contact with the fourth conductive cover plate 24.

In one embodiment of the present disclosure, the fourth conductive housing 14 is made of a metal material and has an integrated structure. The fourth conductive housing 14 includes a fourth main body portion 141, a fourth mating portion 142 extending forwardly from one end (for example, a front end) of the fourth main body portion 141, and a fourth extension portion 143 extending downwardly from another end (for example, a rear end) of the fourth main body portion 141. In the illustrated embodiment of the present disclosure, the fourth mating portion 142, the fourth main body portion 141 and the fourth extension portion 143 are integrally formed to improve the shielding effect. Specifically, in the illustrated embodiment of the present disclosure, the fourth extension portion 143 extends downwardly from the fourth main body portion 141.

In the illustrated embodiment of the present disclosure, the fourth conductive housing 14 includes a plurality of fourth terminal installation slots 140 located on an inner surface (for example, an upper surface) thereof, and a plurality of fourth partition walls 144 each separating two adjacent fourth terminal installation slots 140. Specifically, the fourth terminal installation slots 140 are provided on an upper surface of the fourth mating portion 142 and an upper surface of the fourth main body portion 141.

The fourth mating portion 142 includes a fourth end surface 1421 (for example, a front end surface), a plurality of fourth installation grooves 1422 adjacent to the fourth end surface 1421, and a plurality of fourth positioning posts 1424 protruding downwardly.

A plurality of second positioning protrusions 1411 for being inserted into the second positioning slots 1230 are provided on two sides of the fourth main body portion 141, respectively. the second positioning protrusions 1411 abut against the first positioning protrusions 1311 along the third direction A3-A3 to fix the third terminal module M3 and the fourth terminal module M4 on the upper and lower sides of the mating slot 10, respectively. Besides, a bottom end of the fourth extension portion 143 further includes a plurality of fourth shielding protrusions 1431 and a plurality of fourth receiving grooves 1432 of which each is located between two adjacent fourth shielding protrusions 1431.

The fourth conductive cover plate 24 is located on the inner side of the fourth conductive housing 14 and at least partially covers the fourth terminal installation slots 140. In the illustrated embodiment of the present disclosure, the fourth conductive cover plate 24 is made of a metal material to improve the shielding effect. At least part of the fourth terminal installation slot 140 is surrounded by the fourth conductive housing 14 and the fourth conductive cover plate 24. Therefore, a better shielding is formed for the fourth terminal assembly 34 located in the fourth terminal installation groove 140 to improve the quality of signal transmission. In the illustrated embodiment of the present disclosure, the shape of the fourth conductive cover plate 24 matches the inner surface of the fourth conductive housing 14 so that the fourth conductive cover plate 24 can fit better on the inner side of the fourth conductive housing 14. The fourth conductive cover plate 24 is fixed to the inner side of the fourth conductive housing 14 by soldering or welding. Specifically, the fourth conductive cover plate 24 defines a plurality of fourth openings 240. The fourth openings 240 correspond to the fourth shielding protrusions 1431 to facilitate soldering or welding. In the illustrated embodiment of the present disclosure, the fourth conductive cover plate 24 generally covers the upper surface of the fourth main body portion 141 and the inner surface of the fourth extension portion 143. The fourth conductive cover plate 24 does not completely cover the upper surface of the fourth mating portion 142. In the illustrated embodiment of the present disclosure, the fourth conductive cover plate 24 is provided with a fourth protruding portion 241 that protrudes above the fourth mating portion 142. The fourth protruding portion 241 is generally flat-shaped.

The fourth terminal assembly 34 includes a plurality of fourth insulating fixing blocks 341 and a plurality of fourth signal terminals 342 fixed to the fourth insulating fixing blocks 341. The fourth terminal assembly 34 is at least partially installed in the fourth terminal installation slot 140. The fourth signal terminal 342 includes a fourth middle portion 3421, a fourth signal elastic arm portion 3422 extending from one end (for example, a front end) of the fourth middle portion 3421, and a fourth tail portion 3423 extending from another end (for example, a rear end) of the fourth middle portion 3421. The fourth insulating fixing blocks 341 are at least fixed on the fourth middle portion 3421 and are received in the fourth terminal installation slot 140. The fourth signal elastic arm portion 3422 at least partially protrudes into the second mating slot 1223. Specifically, the fourth signal flare arm portion 3422 includes a fourth signal contact portion 3422a configured to contact the conductive pad 302 of the mating module 300. The fourth signal terminals 342 do not contact the fourth conductive housing 14 nor the fourth conductive cover plate 24 to prevent short circuit.

In the illustrated embodiment of the present disclosure, the fourth conductive housing 14 covers the fourth signal flare arm portion 3422, the fourth middle portion 3421 and the fourth tail portion 3423 of the fourth signal terminal 342 along a length direction of the fourth signal terminal 342, so that most of the fourth signal terminal 342 is covered along its entire length direction, thereby improving the shielding effect. For example, the fourth conductive housing 14 covers at least 90% of the fourth signal flare arm portion 3422, at least 90% of the fourth middle portion 3421 and at least 90% of the fourth tail portion 3423 of the fourth signal terminal 342 along the length direction of the fourth signal terminal 342. Preferably, the fourth conductive housing 14 completely covers the fourth signal flare arm portion 3422, the fourth middle portion 3421 and the fourth tail portion 3423 of the fourth signal terminal 342 along the length direction of the fourth signal terminal 342, so that a full coverage in the entire length direction of the fourth signal terminal 342 is achieved, thereby further improving the shielding effect.

In the illustrated embodiment of the present disclosure, two fourth signal terminals 342 are provided in the fourth terminal assembly 34, and form a fourth differential pair DP4 to increase the signal transmission rate. The plurality of fourth insulating fixing blocks 341 are formed on the two fourth signal terminals 342. The plurality of fourth insulating fixing blocks 341 are arranged at intervals along the length direction of the fourth signal terminal 342. After the fourth insulating fixing blocks 341 are installed in the fourth terminal installation slot 140, the fourth signal terminal 342 is suspended in the fourth terminal installation slot 140, thereby avoiding contact the fourth conductive housing 13 to prevent short circuit. Of course, it is understandable to those skilled in the art that the number and shape of the fourth insulating fixing blocks 341 can be flexibly adjusted as needed, which will not be described in detail in the present disclosure.

The shape of the fourth signal terminal 342 matches the fourth terminal installation slot 140. Specifically, in the illustrated embodiment of the present disclosure, the fourth tail portion 3423 is configured to be electrically connected to the fourth soldering pad 204 of the circuit board 200. For example, the fourth tail portion 3423 is fixed to the fourth soldering pad 204 by soldering or welding. In the illustrated embodiment of the present disclosure, the fourth tail portions 3423 of the fourth signal terminals 342 in the fourth differential pair DP4 are located in the fourth receiving grooves 1432. The fourth tail portions 3423 of the fourth signal terminals 342 in the fourth differential pair DP4 are shielded by the fourth shielding protrusions 1431 on two sides thereof to reduce the probability of crosstalk with other fourth signal terminals 342 when transmitting signals, thereby improving the quality of signal transmission.

The fourth insulating block 44 mates with the fourth mating portion 142 of the fourth conductive housing 14. In one embodiment of the present disclosure, the fourth insulating block 44 is insert-molded in the fourth mounting grooves 1422 of the fourth mating portion 142 so that the fourth insulating block 44 and the fourth mating portion 142 are tightly fixed together. Of course, in other embodiments of the present disclosure, the fourth insulating block 44 can be fixed in the fourth installation groove 1422 of the fourth mating portion 142 in other ways, for example, by assembly.

The fourth insulating block 44 includes a fourth front end surface 440 which is flush with the fourth end surface 1421 of the fourth mating portion 142. Besides, the fourth insulating block 44 further includes a plurality of fourth slits 441 and a plurality of fourth slots 442. The fourth signal arm portion 3422 of the fourth signal terminal 342 at least partially extends into the fourth slit 441. By disposing the fourth insulating block 44 adjacent to the front end of the second mating slot 1223, on the one hand, protection can be provided for the fourth signal elastic arm portion 3422 of the fourth signal terminal 342, and on the other hand, it also reduces the risk of the fourth signal terminal 342 being touched by other components and causing a short circuit.

The fourth ground plate 54 is made of a metal material. In the illustrated embodiment of the present disclosure, the fourth ground plate 54 is generally U-shaped, and includes a fourth fixing portion 541 installed on the fourth mating portion 142, a plurality of fourth spacing arms 542 extending forwardly and upwardly from the fourth fixing portion 541, and a plurality of fourth ground elastic arm portions 543 extending backwardly and upwardly from the fourth spacing arms 542. In the illustrated embodiment of the present disclosure, the fourth spacing arms 542 are spaced apart along the second direction A2-A2. The fourth ground elastic arm portions 543 are arranged at intervals along the second direction A2-A2. The fourth ground elastic arm portions 543 are located above the fourth fixing portion 541. The fourth ground elastic arm portion 543 includes a fourth ground contact portion 5431 configured to contact the conductive pad 302 of the mating module 300.

Specifically, the fourth fixing portion 541 defines a plurality of fourth positioning holes 5411 that mate with the fourth positioning posts 1424. The fourth fixing portion 541 is in contact with the lower surface of the fourth mating portion 142. The fourth fixing portion 541 is located outside the second mating slot 1223. With this arrangement, the fourth fixing portion 541 can be less restricted by the second mating slot 1223, so that its grounding area can be adjusted more flexibly to improve the grounding effect.

The fourth ground plate 54 includes a plurality of fourth openings 544 of which each is located between two adjacent fourth spacing arms 542. The fourth insulating block 44 is at least partially located in the fourth opening 544. In other words, the fourth spacing arm 542 is at least partially located in the fourth slot 442.

The fourth ground elastic arm portion 543 extends along the fourth insulating block 44 into the second mating slot 1223. The fourth ground contact portion 5431 is located beside the fourth signal contact portions 3422a of the fourth differential pair DP4 along the second direction A2-A2 to improve the shielding effect.

The fourth ground plate 54 further includes a plurality of fourth contact portions 545 extending from the fourth ground elastic arm portions 543 and a fourth connecting portion 546 connecting to the fourth contact portions 545.

The fourth ground plate 54 is in contact with at least one of the fourth conductive cover plate 24 and the fourth conductive housing 14 to improve the shielding effect. In the illustrated embodiment of the present disclosure, the fourth ground plate 54 and the fourth conductive cover plate 24 are two components and are in contact with each other. Specifically, the fourth contact portion 545 is in contact with the fourth protruding portion 241 of the fourth conductive cover plate 24. Of course, it is understandable to those skilled in the art that in other embodiments of the present disclosure, the fourth ground plate 54 and the fourth conductive cover plate 24 can also be integrally formed into one piece.

During assembly, the first terminal module M1, the second terminal module M2, the third terminal module M3, and the fourth terminal module M4 themselves are assembled in advance. Then, the third terminal module M3 is installed in the first receiving space 115 of the first terminal module M1. At this time, the first side wall 1151 and the second side wall 1152 of the first extension portion 113 can form a shield for the third terminal module M3 in the second direction A2-A2, which is beneficial to improving the quality of signal transmission. Similarly, the fourth terminal module M4 is installed in the second receiving space 125 of the second terminal module M2. At this time, the third side wall 1251 and the fourth side wall 1252 of the second extension portion 123 can form a shield for the fourth terminal module M4 in the second direction A2-A2, which is beneficial to improving the quality of signal transmission. Finally, a first sub-assembly SA1 formed by the first terminal module M1 and the third terminal module M3, and a second sub-assembly SA2 formed by the second terminal module M2 and the fourth terminal module M4 are fixed together to form the electrical connector 100 of the present disclosure. The first signal elastic arm portions 3122 and the third signal elastic arm portions 3322 are spaced apart along an extension direction (i.e., the first direction A1-A1) of the mating slot 10. The second signal elastic arm portions 3222 and the fourth signal elastic arm portions 3422 are spaced apart along the extension direction of the mating slot 10.

Compared with the prior art, the first terminal module M1 of the present disclosure includes the first conductive housing 11 and the first conductive cover plate 21. The first conductive cover plate 21 is located on the inner side of the first conductive housing 11 and at least partially covers the first terminal installation slots 110. At least part of the first terminal installation slot 110 is surrounded by the first conductive housing 11 and the first conductive cover plate 21 to improve the shielding effect on the first signal terminal 312. In addition, the first conductive housing 11 covers the first middle portion 3121 of the first signal terminal 312, the first signal flare arm portion 3122 and the first tail portion 3123 along the length direction of the first signal terminal 312. As a result, the first conductive housing 11 covers most of the first signal terminal 312 in the length direction of the first signal terminal 312, further improving the shielding effect on the first signal terminal 312. Furthermore, the first conductive housing 11 is of an integral piece, which is beneficial to improve the stability of signal shielding and has good anti-crosstalk performance. By providing the first conductive housing 11 of the integral piece, it is also beneficial to improve the consistency of the first terminal installation slot 110 and improve the stability of high-frequency signal transmission.

The second terminal module M2, the third terminal module M3 and the fourth terminal module M4 have similar structures to the first terminal module M1, and therefore also have beneficial effects similar to those of the first terminal module M1, which will not be described again in the present disclosure. Besides, the first terminal module M1, the second terminal module M2, the third terminal module M3 and the fourth terminal module M4 of the present disclosure can be designed independently, have a simple structure, can realize multiple stacks freely, and are simple to manufacture.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A first terminal module, comprising:
a first conductive housing, the first conductive housing comprising a first main body portion, a first mating portion extending from one end of the first main body portion, and a first extension portion extending from another end of the first main body portion;
a first conductive cover plate, the first conductive cover plate being located on an inner side of the first conductive housing; and
a first terminal assembly, the first terminal assembly comprising a first insulating fixing block and a plurality of first signal terminals fixed to the first insulating fixing block; the first terminal assembly being at least partially located between the first conductive housing and the first conductive cover plate; each first signal terminal comprising a first middle portion, a first signal elastic arm portion extending from one end of the first middle portion, and a first tail portion extending from another end of the first middle portion; the first signal elastic arm portion comprising a first signal contact portion configured to be in contact with a mating module; the first signal terminals being not in contact with the first conductive housing;
wherein the first conductive housing covers the first signal elastic arm, the first middle portion and the first tail portion of the first signal terminal along a length direction of the first signal terminal.

2. The first terminal module according to claim 1, wherein the first mating portion, the first main body portion and the first extension portion are integrally formed.

3. The first terminal module according to claim 2, wherein the first mating portion and the first main body portion are in a step-shaped configuration; the first extension portion extends obliquely from the first main body portion.

4. The first terminal module according to claim 1, wherein the first conductive housing defines a first terminal installation slot located on an inner surface thereof; the first terminal assembly is at least partially installed in the first terminal installation slot; the first conductive cover plate at least partially covers the first terminal installation slot; at least part of the first terminal installation slot is surrounded by the first conductive housing and the first conductive cover plate.

5. The first terminal module according to claim 1, further comprising:
a first insulating block, the first insulating block being configured to mate with the first mating portion of the first conductive housing; the first insulating block defines a plurality of first slits; the first signal arm of the first signal terminal extending beyond the first conductive cover plate and at least partially extending into the first slit;
a first ground plate, the first ground plate comprising a plurality of first ground elastic arm portions; each first ground elastic arm portion comprising a first ground contact portion configured to contact the mating module; the first ground contact portion being located beside the first signal contact portion; the first ground plate being in contact with at least one of the first conductive cover plate and the first conductive housing.

6. The first terminal module according to claim 5, wherein the first ground plate and the first conductive cover plate are two components and are in contact with each other.

7. The first terminal module according to claim 5, wherein the first ground plate comprises a first fixing portion fixed to the first mating portion and a plurality of first spacing arms extending from the first fixing portion and disposed at intervals; each first ground elastic arm portion extends from a corresponding first spacing arm.

8. The first terminal module according to claim 7, wherein the first ground plate further comprises a first contact portion extending from the first ground elastic arm portion and a first connecting portion connected to the first contact portion; the first contact portion is in contact with the first conductive cover plate.

9. The first terminal module according to claim 7, wherein the first mating portion comprises a first end surface, a first mounting groove disposed adjacent to the first end surface, and a first mating slot extending through the first end surface; the first insulating block is fixed in the first mounting groove; the first signal contact portion and the first ground contact portion both protrude into the first mating slot.

10. The first terminal module according to claim 9, wherein the first ground plate comprises a plurality of first openings each located between two adjacent first spacing arms; the first insulating block is at least partially located in the first opening;
the first insulating block defines a plurality of first slots; the first spacing arm is located at least partially within the first slot;
the first fixing portion is located outside the first mating slot.

11. The first terminal module according to claim 1, wherein the first middle portion comprises a first front end portion connected to the first signal elastic arm portion, a first inclined portion extending upwardly and backwardly from a rear end of the first front end portion, a first straight portion extending backwardly from a rear end of the first inclined portion, and a second inclined portion extending downwardly and backwardly from a rear end of the first straight portion; the first tail portion is connected to the second inclined portion; the first tail is configured to be electrically connected to a circuit board.

12. The first terminal module according to claim 11, wherein the first conductive cover plate is bent in such a manner to be adapted to the first front end portion, the first inclined portion, the first straight portion and the second inclined portion.

13. The first terminal module according to claim 1, wherein the first conductive cover plate is fixed to the inner side of the first conductive housing by welding or soldering; two first signal terminals are provided in the first terminal assembly so as to form a first differential pair.

14. An electrical connector, comprising:
a first terminal module, the first terminal module, comprising:
a first conductive housing, the first conductive housing comprising a first main body portion, a first mating portion extending from one end of the first main body portion, and a first extension portion extending from another end of the first main body portion;
a first conductive cover plate, the first conductive cover plate being located on an inner side of the first conductive housing; and
a first terminal assembly, the first terminal assembly comprising a first insulating fixing block and a plurality of first signal terminals fixed to the first insulating fixing block; the first terminal assembly being at least partially located between the first conductive housing and the first conductive cover plate; each first signal terminal comprising a first middle portion, a first signal elastic arm portion extending from one end of the first middle portion, and a first tail portion extending from another end of the first middle portion; the first signal elastic arm portion comprising a first signal contact portion configured to be in contact with a mating module; the first signal terminals being not in contact with the first conductive housing;
wherein the first conductive housing covers the first signal elastic arm, the first middle portion and the first tail portion of the first signal terminal along a length direction of the first signal terminal; and
a second terminal module, the second terminal module comprising:
a second conductive housing, the second conductive housing comprising a second main body portion, a second mating portion extending from one end of the second main body portion, and a second extension portion extending from another end of the second main body portion;
a second conductive cover plate, the second conductive cover plate being located on an inner side of the second conductive housing; and
a second terminal assembly, the second terminal assembly comprising a second insulating fixing block and a plurality of second signal terminals fixed to the second insulating fixing block; the second terminal assembly being at least partially located between the second conductive housing and the second conductive cover plate; each second signal terminal comprising a second middle portion, a second signal elastic arm portion extending from one end of the second middle portion, and a second tail portion extending from another end of the second middle portion; the second signal elastic arm portion comprising a second signal contact portion configured to contact the mating module; the second signal terminals being not in contact with the second conductive housing;
wherein the second conductive housing covers the second signal elastic arm portion, the second middle portion and the second tail portion of the second signal terminal along a length direction of the second signal terminal; and
wherein the first conductive housing of the first terminal module is in contact with the second conductive housing of the second terminal module to form a mating slot between the first conductive housing and the second conductive housing; the first signal contact portion of the first terminal module protrudes into the mating slot from one side, and the second signal contact portion of the second terminal module protrudes into the mating slot from an opposite side; the mating slot is configured to receive the mating module; the mating module is in contact with the first signal contact portion and the second signal contact portion.

15. The electrical connector according to claim 14, wherein the second conductive housing defines a plurality of second terminal installation slots located on an inner surface thereof; the second terminal assembly is at least partially installed in the second terminal installation slot; the second conductive cover plate at least partially covers the second terminal installation slot; at least part of the second terminal installation slot is surrounded by the second conductive housing and the second conductive cover plate.

16. The electrical connector according to claim 14, wherein the second terminal module further comprises:
a second insulating block, the second insulating block being configured to mate with the second mating portion of the second conductive housing; the second insulating block defining a plurality of second slits; the second signal elastic arm of the second signal terminal extending beyond the second conductive cover plate and at least partially extending into the second slit; and
a second ground plate, the second ground plate comprising a plurality of second ground elastic arm portions; each second ground elastic arm portion comprising a second ground contact portion configured to contact the mating module; the second ground contact portion being located beside the second signal contact portion; the second ground plate being in contact with at least one of the second conductive cover plate and the second conductive housing.

17. The electrical connector according to claim 16, further comprising a third terminal module at least partially assembled in the first terminal module; the third terminal module comprising:
a third conductive housing, the third conductive housing comprising a third main body portion, a third mating portion extending from one end of the third main body portion, and a third extension portion extending from another end of the third main body portion; the third conductive housing defining a plurality of third terminal installation slot located on an inner surface thereof;
a third conductive cover plate, the third conductive cover plate being located on an inner side of the third conductive housing and at least partially covering the third terminal installation slots; at least part of the third terminal installation slot being surrounded by the third conductive housing and the third conductive cover plate;
a third terminal assembly, the third terminal assembly comprising a third insulating fixing block and a plurality of third signal terminals fixed to the third insulating fixing block; the third terminal assembly being at least partially installed in the third terminal installation slot; each third signal terminal comprising a third middle portion, a third elastic arm portion extending from one end of the third middle portion, and a third tail portion extending from another end of the third middle portion; the third insulating fixing block being at least fixed on the third middle portion and being received in the third terminal installation slot; the third signal elastic arm portion comprising a third signal contact portion configured to contact the mating module; the third signal terminals being not in contact with the third conductive housing;
a third insulating block, the third insulating block being configured to mate with the third mating portion of the third conductive housing; the third insulating block defining a plurality of third slits; the third signal elastic arm of the third signal terminal at least partially extending into the third slit; and
a third ground plate, the third ground plate comprising a plurality of third ground elastic arm portions; the third ground elastic arm portion comprising a third ground contact portion configured to contact the mating module; the third ground contact portion being located beside the third signal contact portion; the third ground plate being in contact with at least one of the third conductive cover plate and the third conductive housing;
wherein the third conductive housing covers the third signal elastic arm, the third middle portion and the third tail portion of the third signal terminal along a length direction of the third signal terminal.

18. The electrical connector of claim 17, further comprising a fourth terminal module at least partially assembled in the second terminal module; the fourth terminal module comprising:
a fourth conductive housing, the fourth conductive housing comprising a fourth main body portion, a fourth mating portion extending from one end of the fourth main body portion, and a fourth extension portion extending from another end of the fourth main body portion; the fourth conductive housing defining a plurality of fourth terminal installation slots located on an inner surface thereof;
a fourth conductive cover plate, the fourth conductive cover plate being located on an inner side of the fourth conductive housing and at least partially covering the fourth terminal installation slots; at least part of the fourth terminal installation slot being surrounded by the fourth conductive housing and the fourth conductive cover plate;
a fourth terminal assembly, the fourth terminal assembly comprising a fourth insulating fixing block and a plurality of fourth signal terminals fixed to the fourth insulating fixing block; the fourth terminal assembly being at least partially installed in the fourth terminal installation slot; each fourth signal terminal comprising a fourth middle portion, a fourth elastic arm portion extending from one end of the fourth middle portion, and a fourth tail portion extending from another end of the fourth middle portion; the fourth insulating fixing block being at least fixed on the fourth middle portion and being received in the fourth terminal installation slot; the fourth signal elastic arm portion comprising a fourth signal contact portion configured to contact the mating module; the fourth signal terminals being not in contact with the fourth conductive housing;
a fourth insulating block, the fourth insulating block being configured to mate with the fourth mating portion of the fourth conductive housing; the fourth insulating block defining a plurality of fourth slits; the fourth signal elastic arm portion of the fourth signal terminal at least partially extending into the fourth slit; and
a fourth ground plate, the fourth ground plate comprising a plurality of fourth ground elastic arm portions; the fourth ground elastic arm portion comprising a fourth ground contact portion configured to contact the mating module; the fourth ground contact portion being located beside the fourth signal contact portion; the fourth ground plate being in contact with at least one of the fourth conductive cover plate and the fourth conductive housing;
wherein the fourth conductive housing covers the fourth signal elastic arm portion, the fourth middle portion and the fourth tail portion of the fourth signal terminal along a length direction of the fourth signal terminal.

19. The electrical connector according to claim 18, wherein the first elastic arm portion and the third elastic arm portion are spaced apart along an extension direction of the mating slot; the second elastic arm portion and the fourth elastic arm portion are spaced apart along the extension direction of the mating slot.

20. The electrical connector according to claim 18, wherein the third conductive housing comprises a plurality of first positioning protrusions protruding toward the fourth conductive housing; the fourth conductive housing comprises a plurality of second positioning protrusions protruding toward the third conductive housing; the first positioning protrusions and the second positioning protrusions are abutted against with each other;
the first conductive housing and the second conductive housing are fixed together by welding or soldering.
